(19) United States
(12) Patent Application Publication
(10) Pub. No.: US 2008/0277899 A1
(43) Pub. Date: Nov. 13, 2008

(54) Bicycle fender

(75) Inventor: Kuo-Chung Hsu, Hsiushui Hsiang (TW)

Correspondence Address: BRUCE H. TROXELL;SUITE 1404, 5205 LEESBURG PIKE, FALLS CHURCH, VA, 22041, US

(73) Assignee: SUNNYWHEEL INDUSTRIAL CO., LTD.

(21) Appl. No.: 11/798,317

(22) Filed: May 11, 2007

(51) Int. Cl. B62K 3/02

(52) U.S. Cl. 280/281.1

(57) ABSTRACT

A bicycle fender to provide multi-color combinations and selections includes a frame and a plate. The frame has a body formed in a profile of a fender and a flange extended from an inner side of the periphery with a plurality of first fastening elements formed thereon. The plate is mounted onto the frame and has second fastening elements on the periphery corresponding to the first fastening elements. Thereby the invention can provide different colors and patterns to allow users to change different colors and patterns according to their requirements.

### BACKGROUND OF THE INVENTION

1. Field of the Invention

The present invention relates to a bicycle fender and particularly to a bicycle fender that has multi-color combinations to suit individual user's requirements.

2. Description of the Prior Art

A conventional bicycle fender 9 (referring to FIG. 1) mainly includes a plate 90 and a fastening joint 91 at a front end to be fastened to a bicycle body. The fender 9 thus formed usually looks monotonous and does not have much appeal. While some vendors try to bond stickers to the plate 90 to enhance the appeal, the area being covered is limited. It still does not improve the overall appeal very much.

### SUMMARY OF THE INVENTION

In view of the aforesaid problem, the present invention aims to provide a bicycle fender that has multi-color combinations. It mainly includes a frame and a plate. The frame has a body with the periphery formed in a profile of a fender and a flange extended from an inner side of the periphery. The flange has a plurality of first fastening elements. The plate is mounted onto the frame and has second fastening elements on the periphery corresponding to the first fastening elements. By means of the construction set forth above, users can select and configure the fender with different colors and patterns according to their requirements

The plate may be a fabric with a plurality of apertures formed on the periphery corresponding to the first fastening elements to allow at least one rope to thread through to form the second fastening elements to fasten to the first fastening elements.

In another aspect the frame has a head end connected to a coupling element.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a perspective view of a conventional fender.

FIG. 2 is a perspective view of the frame of the invention.

FIG. 3 is a perspective view of the invention.

FIG. 4 is a cross section of the invention.

FIG. 5 is an exploded view of another embodiment of the invention.

FIG. 6 is a perspective view of another embodiment of the invention.

FIG. 7 is a cross section of another embodiment of the invention.

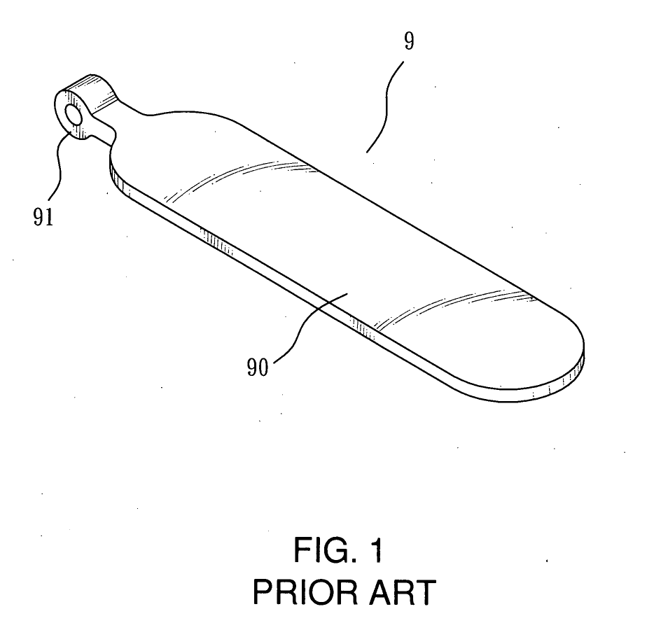

### DESCRIPTION OF THE PREFERRED EMBODIMENTS

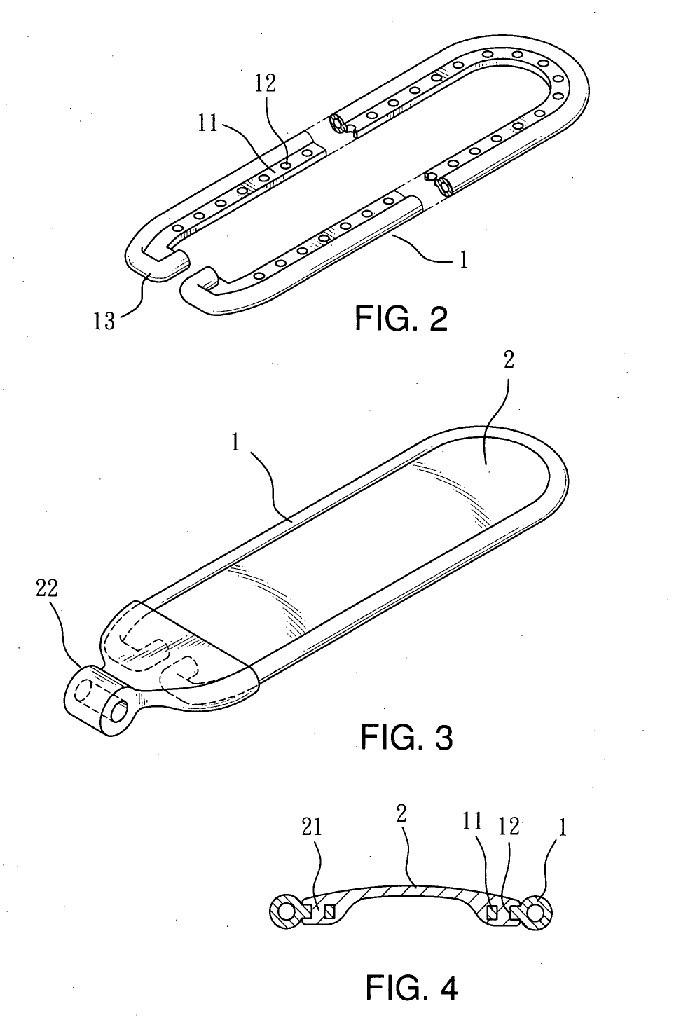

Referring to FIGS. 2, 3 and 4, the bicycle fender according to the invention includes a frame 1 and a plate 2.

The frame 1 has a body formed in a profile of a fender and has a flange 11 extended from an inner side of the periphery. The flange 11 has a plurality of first fastening elements 12 which may be apertures to fasten the plate 2. The frame 1 further has a head end 13 which is connected a coupling element 22 to be fastened to a bicycle body.

The plate 2 is mounted onto the frame 1, and has second fastening elements 21 formed on the periphery corresponding to the first fastening elements 12.

The plate 2 may be made from plastics. The second fastening elements 21 and the first fastening elements 12 may be integrally formed. By means of such a structure the frame 1 and the plate 2 may be coupled in different color combinations to overcome the shortcomings of monotonous design or bonding with stickers of the conventional bicycle fender.

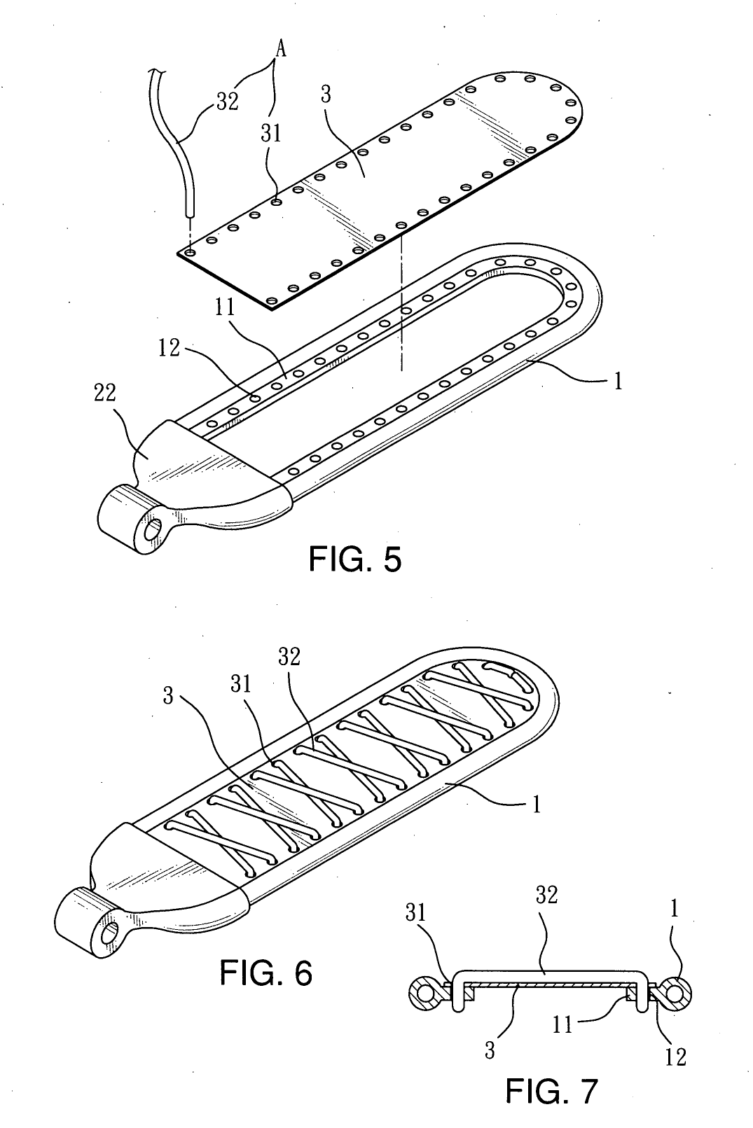

Refer to FIGS. 5, 6 and 7 for another embodiment of the invention. The plate 3 may be a fabric with a plurality of apertures 31 formed on the periphery corresponding to the first fastening elements 12 of the frame 1 to allow at least one rope 32 to thread through the apertures to become a second fastening element A to couple with the first fastening elements 12. Such a structure makes the color and pattern of the plate 3 more versatile and can better satisfy user's requirements.

In short, the invention allows users to select different colors and patterns to form a desired combination according to their requirements. It offers a significant improvement over the conventional techniques.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

I claim:

1. A bicycle fender comprising a frame and a plate; wherein:
the frame has a body formed in a profile of a fender and a flange extended from an inner side of the periphery thereof, the flange having a plurality of first fastening elements formed thereon; and the plate is mounted onto the frame and has second fastening elements on the periphery thereof corresponding to the first fastening elements of the frame.

2. The bicycle fender of claim 1, wherein the frame has a head end which is connected to a coupling element.

3. The bicycle fender of claim 1, wherein the plate is made from plastics, the second fastening elements being integrally formed with the first fastening elements of the frame.

4. The bicycle fender of claim 1, wherein the plate is a fabric which has a plurality of apertures formed on the periphery corresponding to the first fastening elements to be threaded through by at least one rope to form the second fastening elements to couple with the first fastening elements.

5. The bicycle fender of claim 1, wherein the first fastening elements are apertures.
